(19) United States
(12) Patent Application Publication
(10) Pub. No.: US 2017/0340176 A1
(43) Pub. Date: Nov. 30, 2017

(54) DRONE CLEANING DEVICE

(71) Applicant: HON HAI PRECISION INDUSTRY CO., LTD., New Taipei (TW)

(72) Inventor: CHIA-HUNG LIAO, New Taipei (TW)

(21) Appl. No.: 15/400,966

(22) Filed: Jan. 7, 2017

(30) Foreign Application Priority Data
May 27, 2016 (TW) 105116779

(51) Int. Cl. A47L 1/02; B64D 45/00; B64C 39/02; G05D 1/10; B64D 47/08

(52) U.S. Cl. CPC A47L 1/02; G05D 1/101; B64D 47/08; B64C 39/024; B64D 45/00; B64C 2201/042; B64C 2201/12

(57) ABSTRACT

A drone cleaning device for a building exterior comprises a main frame, a plurality of branch shafts set to the main frame, a plurality of power elements respectively set to the branch shafts, a plurality of adjustable supports set to the main frame, a plurality of rotatable elements respectively set to the adjustable supports and are configured to rotate relative to the adjustable supports, and a plurality of cleaning elements respectively set to the rotatable elements.

### BACKGROUND

### 1. Technical Field

The disclosure relates to a drone and, particularly, to a drone cleaning device for a building exterior.

### 2. Description of the Related Art

In general, most of exterior glasses of buildings need to use artificial window washing with lifts for cleaning. If a cable for lifting the lifts is broken, a workman fall down, thus suffering a high life-threatening risk and having a high labor cost.

Therefore, it is desirable to provide a drone cleaning device which can overcome the described limitations.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the light source device and the projection device. Moreover, in the drawings, like reference numerals designate corresponding parts throughout the several views.

FIG. 1 is an isometric view showing a configuration of a drone cleaning device according to a first embodiment of the disclosure.

FIG. 2 is a schematic view of an angle-adjustable module on an adjustable support of FIG. 1.

FIG. 3 is a schematic view of a flight controlling system of the drone cleaning device of FIG. 1.

FIG. 4 is a schematic view of a distance detecting module of FIG. 3.

FIG. 5 is a schematic view of a visual recognition module of FIG. 3.

FIG. 6 is a schematic view of a power alarming module of FIG. 3.

### DETAILED DESCRIPTION OF THE EMBODIMENTS

Embodiments of the drone cleaning device are described in detail here with reference to the drawings.

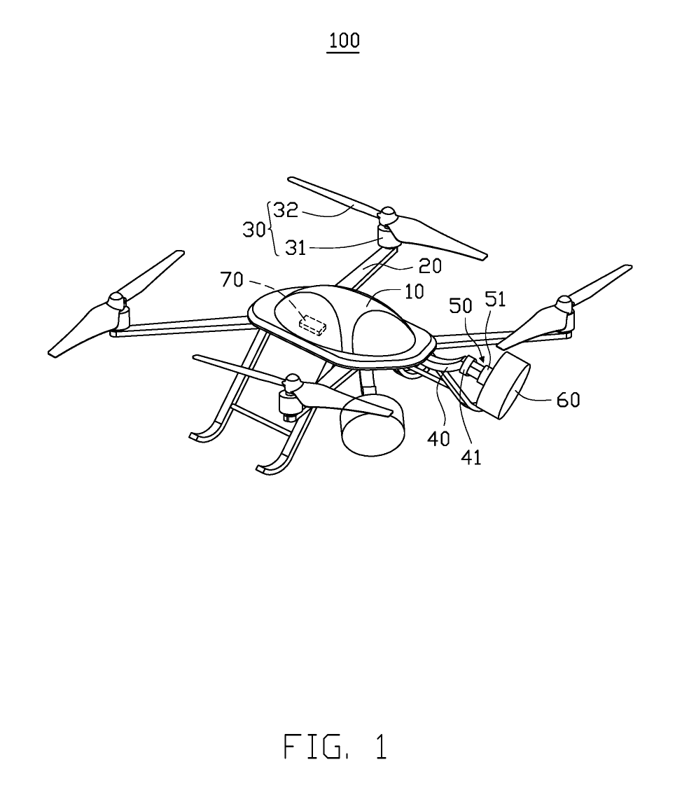

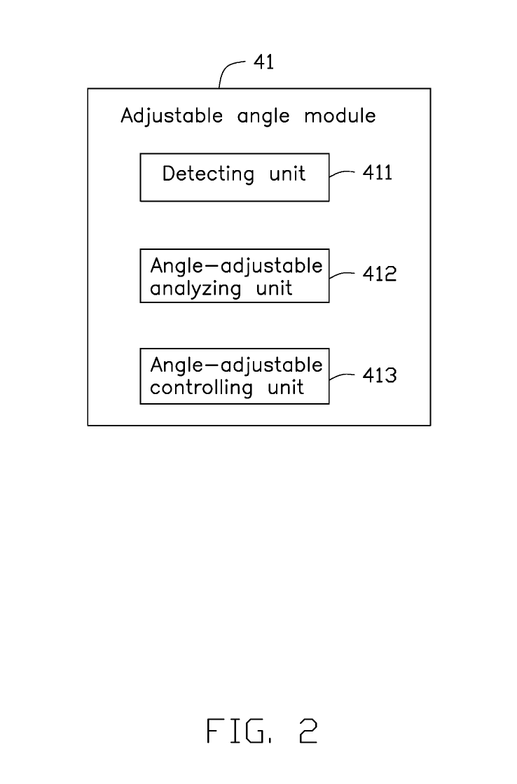

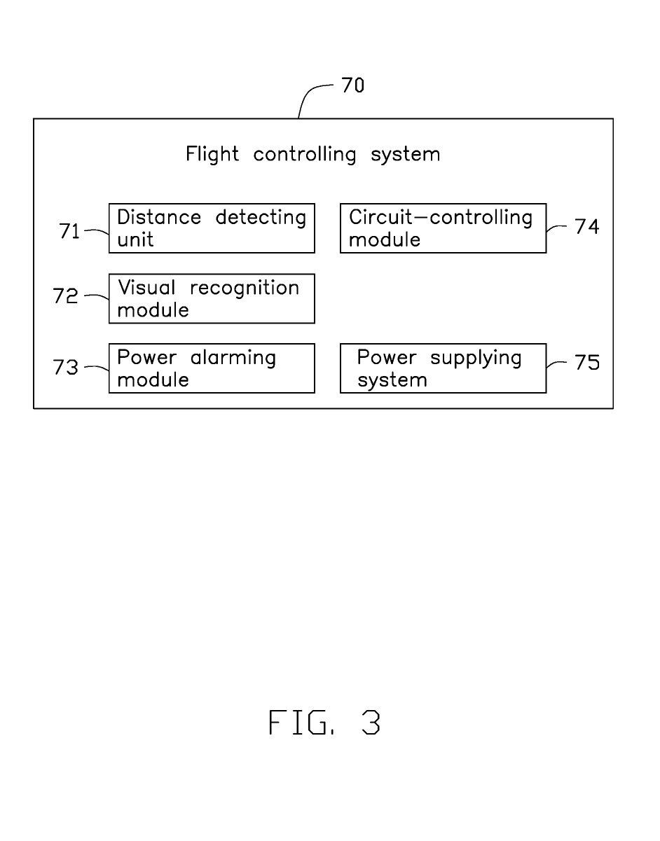

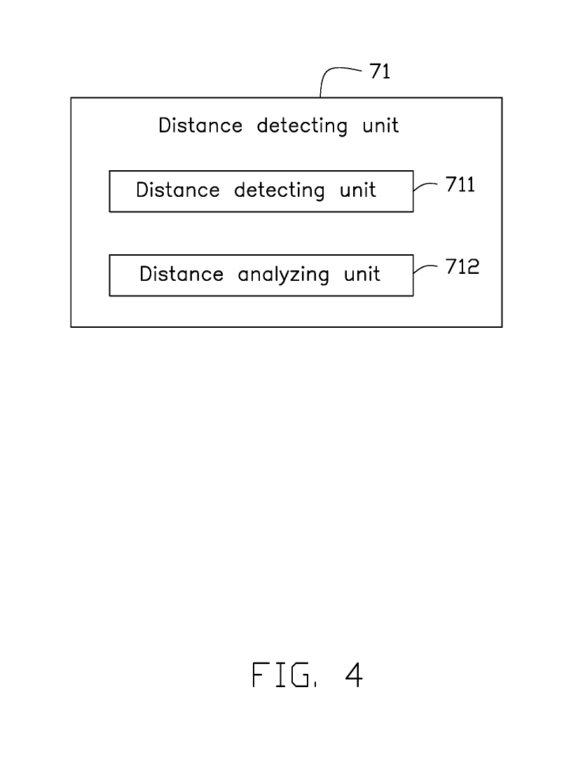

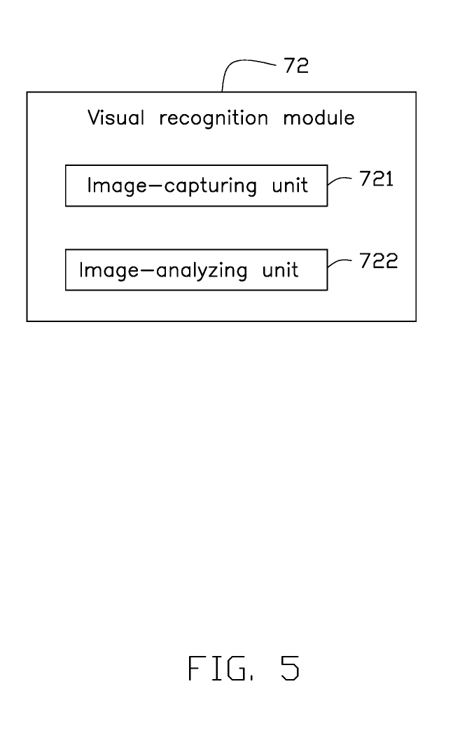

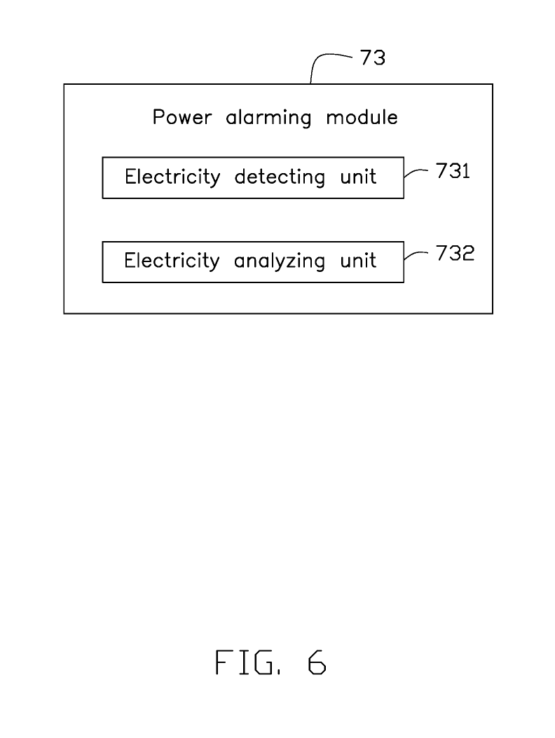

Referring to FIGS. 1-6, a drone cleaning device 100 comprises a main frame 10, a plurality of branch shafts 20, a plurality of power elements 30, a plurality of adjustable supports 40, a plurality of rotatable elements 50, a plurality of cleaning elements 60 and a flight controlling system 70.

The main frame 10 presents flat shape and a side of the main frame 10 along a horizontal direction is larger than a side of the main frame 10 along a vertical direction so as to reduce a wind resistance toward the horizontal direction and decrease a crosswind effect.

Each of the branch shafts 20 has one end assembled onto the main frame 10 and the other end extending a direction away from the main frame 10.

The power elements 30 are respectively set onto the end away from the main frame 10. Each of the power elements 30 comprises a driving module 31 and a propeller 32. The driving module 31 is set to the end of the branch shaft 20 away from the main frame 10. The propeller 32 is set to the driving module 31 and is driven to rotate by the driving module 31 so that the drone cleaning device 100 acquires more power of the flight.

The adjustable supports 40 are set to the main frame 10 and are provided to support the drone cleaning device 100 when the drone cleaning device 100 lands on the ground. Each of the adjustable supports 40 has an adjustable angle module 41 for adjusting the adjustable supports 40 in need.

The adjustable angle module 41 comprises a sensing unit 411, an angle-adjustable analyzing unit 412 and an angle-adjustable controlling unit 413. The sensing unit 411 is configured to sense pressure signals of the rotatable elements 50 sent to the adjustable supports 40 and the angle-adjustable analyzing unit 412 is provided for receiving the sensed pressure signals. The sensing unit 411 may be a pressure sensor, a torque sensor, a load sensor and so on. In this embodiment, the sensing unit 411 is a pressure sensor. The angle-adjustable analyzing unit 412 is configured to restore a best pressure range so that the building exterior is acquired to get a better cleaning when the sensing unit 411 senses the pressure in the best pressure range. The angle-adjustable analyzing unit 412 is configured to receive sensed pressure signal from the sensor 411 and judge whether the sensed pressure signal is in the best pressure range. If the sensed pressure signal is not in the best pressure range, the angle-adjustable analyzing unit 412 provides an adjustable signal to the angle-adjustable controlling unit 413. After the angle-adjustable controlling unit 413 receives the adjustable signal, the adjustable supports 40 are adjusted to the corresponding angles.

The rotatable elements 50 are assembled onto the adjustable supports 40 and are rotated relative to the adjustable supports 40 in the same direction and by the same speed. Each of the rotatable elements 50 comprises a rotatable shaft 51 and a driving motor (not shown). Each of the rotatable shafts 51 has one end set to the corresponding adjustable support 40 and is rotated in respect to the adjustable support 40.

The cleaning elements 60 are fastened to the rotatable shafts 51 away from the ends of the adjustable supports 40 so as to be driven to rotate by the rotatable elements 50 for cleaning the building exterior. Each of the cleaning element 60 further comprises a cleaning part 61 provided for contacting the building exterior to clean and at least a liquid storage (not shown) connected to the cleaning part 61. The liquid storage for cleaning can store water, a detergent and the like.

In this embodiment, the drone cleaning device 100 may be a six-axis rotorcraft which comprises two adjustable supports 40, two rotatable elements 50 and two cleaning elements 60.

The drone cleaning device 100 further comprises a flight controlling system 70 assembled onto the main frame 10. In this embodiment, the flight controlling system 70 is located onto the adjustable support 40 away from the main frame 10. In other embodiment, the flight controlling system 70 may be located into the main frame 10 or other parts.

The flight controlling system 70 comprises a distance detecting module 71, a visual recognition module 72, a power alarming module 73, a circuit-controlling module 74 and a power supplying system 75. The power supplying system 75 is electrically coupled to the distance detecting module 71, the visual recognition module 72, the power alarming module 73 and the circuit-controlling module 74. Actually, the flight controlling system 70 further comprises a gyro, an accelerometer, an electricity regulation and so on.

The distance detecting module 71 is provided for detecting a distance between the drone cleaning device 100 and the building exterior or the other barrier to avoid from a collision. The distance detecting module 71 comprises a distance detecting module 711 and a distance analyzing module 712. The distance detecting module 711 is provided for detecting the distance between the drone cleaning device 100 and the building exterior or the other barrier and sending a detected signal to the distance analyzing module 712. The distance analyzing module 712 defaults a detecting range and sends a barrier signal to the circuit-controlling module 74 if the detected signal is in the detecting range.

The visual recognition module 72 is used to recognize a frame position and range of the building exterior to be cleaned and check the best cleaning spot and the best cleaning route. The visual recognition module 72 comprises an image-capturing unit 721 and an image-analyzing unit 722. The image-capturing unit 721 is used for capturing an image of the building exterior to be cleaned and sending the image to the image-analyzing unit 722. The image-analyzing unit 722 is used for receiving the image sent from the image-capturing unit 721, checking the best cleaning spot and the best cleaning route, and sending a signal of the best cleaning spot and the best cleaning route to the circuit-controlling module 74.

The power alarming module 73 is configured to monitor the remaining electricity and avoid from power shortage of the power supplying system 75. The power alarming module 73 comprises an electricity detecting unit 731 and an electricity analyzing unit 732. The electricity detecting unit 731 is configured to detect the power shortage of the power supplying system 75 and sending a detected signal to the electricity analyzing unit 732. The electricity analyzing unit 732 is configured to receive a detected signal from the electricity detecting unit 731 and compare the remaining electricity with the lowest electricity restored in the electricity analyzing unit 732. When the remaining electricity is less than or equal to the lowest electricity, the electricity analyzing unit 732 is configured to send an alarm signal to the circuit-controlling module 74.

The circuit-controlling module 74 is configured to receive the barrier signal from the distance-analyzing unit 712 and control the drone cleaning device 100 to avoid the collision, receive a command from an operator to control the drone cleaning device 100 flying toward the building exterior, receive the signal of the best cleaning spot and the best cleaning route sent from the image-analyzing unit 722 to control the drone cleaning device 100 cleaning, and receive the alarm signal from the electricity analyzing unit 732 to control the drone cleaning device 100 landing on the ground.

The power supplying system 75 is configured to supply the power to the drone cleaning device 100.

A method of controlling the drone cleaning device 100 cleaning is disclosure. The drone cleaning device 100 is controlled to fly toward the building exterior. At the same time, the rotatable elements 50 is controlled to rotate the same direction and the same speed. If the barrier is detected by the drone cleaning device 100, the distance detecting module 71 is sent a barrier signal to the circuit-controlling module 74 and the distance detecting module 71 is sent the barrier signal to the circuit-controlling module 74 and control the drone cleaning device 100 to avoid the collision. When the drone cleaning device 100 has a flight closing to the building exterior, the visual recognition module 72 captures an image of the building exterior and checks the best cleaning spot and the best cleaning route. The circuit-controlling module 74 controls the best cleaning spot and the best cleaning route cleaning. In this cleaning process, the adjustable angle module 41 adjusts an angle of the adjustable support corresponding to the detected pressure to clean the building exterior exactly. When the cleaning step is finished, the circuit-controlling module 74 controls the drone cleaning device 100 flying back a defaulted position.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A drone cleaning device for a building exterior, comprising:
a main frame;
a plurality of branch shafts set to the main frame;
a plurality of power elements respectively set to the branch shafts;
a plurality of adjustable supports set to the main frame;
a plurality of rotatable elements respectively set to the adjustable supports and configured to rotate relative to the adjustable supports; and
a plurality of cleaning elements respectively set to the rotatable elements.

2. The drone cleaning device of claim 1, wherein each of the adjustable supports has an adjustable angle module, the adjustable angle module comprises a detecting unit, an angle-adjustable analyzing unit and an angle-adjustable controlling unit; the detecting unit is configured to detect pressure of the adjustable supports from the rotatable elements and send a signal of the detected pressure to the angle-adjustable analyzing unit; the angle-adjustable analyzing unit is configured to restore a specific pressure range and receive the signal from the detecting unit to judge whether the detected pressure is in the specific range; the angle-adjustable analyzing unit is configured to send an adjusting signal to the angle-adjustable controlling unit if the detected pressure is not in the specific range; and the adjustable support is controlled to adjust the corresponding angle after the angle-adjustable controlling unit is configured to receive the adjusting signal.

3. The drone cleaning device of claim 1, wherein each of the rotatable element comprises a rotatable shaft and a driving motor, the rotatable shaft has one end set to the adjustable support and rotated in respect to the adjustable support, and the driving motor is configured to drive the rotatable shaft rotating according to the same direction and the same speed.

4. The drone cleaning device of claim 3, wherein each of the cleaning elements is fastened to the rotatable shaft away from one end of each of the adjustable supports.

5. The drone cleaning device of claim 1, further comprising a flight controlling system, the flight controlling system comprising a distance detecting module, a visual recognition module, a power alarming module, a circuit-controlling module and a power supplying system, the power supplying system being electrically coupled to the distance detecting module, the visual recognition module, the power alarming module and the circuit-controlling module.

6. The drone cleaning device of claim 5, wherein the distance detecting module comprises a distance detecting unit and a distance analyzing unit, the distance detecting unit being configured to detect a distance between the building exterior and the drone cleaning device and send a distance signal to the distance analyzing unit, the distance analyzing unit being configured to default a specific range and send a barrier signal to the circuit-controlling module if the distance is in the specific range, and the circuit-controlling module is configured to control the drone cleaning device to avoid collision after receiving the barrier signal.

7. The drone cleaning device of claim 5, wherein the visual recognition module comprises an image-capturing unit and an image-analyzing unit, the image-capturing unit being configured to capture an image of the building exterior to be cleaned and send the image to the image-analyzing unit, the image-analyzing unit being configured to receive the image from the image-capturing unit, check a specific cleaning spot and a specific cleaning route and sending a signal of the specific cleaning spot and the specific cleaning route to the circuit-controlling module, the circuit-controlling module controlling the drone cleaning device to clean according to the specific cleaning spot and the specific cleaning route after receiving the signal of the specific cleaning spot and the specific cleaning route.

8. The drone cleaning device of claim 5, wherein the power alarming module comprises an electricity detecting unit and an electricity analyzing unit, the electricity detecting unit being configured to detect remaining electricity of the power supplying system and send the detected signal to the electricity analyzing unit, the electricity analyzing unit being configured to receive the detected signal from the electricity detecting unit and compare the remaining electricity with a default lowest electricity of the electricity analyzing unit, the electricity analyzing unit sending an alarming signal to the circuit-controlling module if the remaining electricity is less than or equal to the default lowest electricity, the circuit-controlling module sending the alarming signal to control the drone cleaning device landing after receiving the alarming signal.

9. The drone cleaning device of claim 1, wherein the cleaning element comprises a cleaning part and a liquid storage connected to the cleaning part.

10. The drone cleaning device of claim 1, wherein the power elements are respectively set to the branch shafts away from the main frame, each of the power elements comprising a driving module and a propeller, the driving module set to the branch shaft away from the main frame and the propeller set onto the driving module.
